(19) United States
(12) Patent Application Publication
(10) Pub. No.: US 2026/0246658 A1
(43) Pub. Date: Aug. 20, 2026

(54) NETWORK COMMUNICATION SYSTEM WITH COST DETERMINATION FOR COMMUNICATION PATHS

(71) Applicant: Lavu, Inc., Albuquerque (NM)

(72) Inventors: Saleem S. Khatri, Tampa, FL (US); Udayakumar Subbarayan, Sunnyvale, CA (US); Abduraheem Poonthiruthi, Bangalore (IN); Parasmal Praveen Jain, Hyderabad (IN); Yulia Acquatella, Miami, FL (US); Michael Ream McCabe, Albuquerque, NM (US)

(73) Assignee: Lavu, Inc., Albuquerque, NM (US)

(21) Appl. No.: 19/059,214

(22) Filed: Feb. 20, 2025

Related U.S. Application Data
(63) Continuation of application No. 17/932,865, filed on Sep. 16, 2022, now abandoned.
(60) Provisional application No. 63/248,898, filed on Sep. 27, 2021.
(60) Provisional application No. 63/289,063, filed on Dec. 13, 2021.
(60) Provisional application No. 63/297,064, filed on Jan. 6, 2022.
(60) Provisional application No. 63/355,517, filed on Jun. 24, 2022.

(51) Int. Cl. H04L 12/14; H04L 41/22; H04L 45/02; H04L 45/302

(52) U.S. Cl. CPC H04L 12/1428; G06Q 20/20; H04L 41/22; H04L 45/02; H04L 45/306; H04L 45/308

(57) ABSTRACT

A communication system is provided. In some implementations, the communication system may include a cost component arranged in communication with the communication component and configured to determine costs associated with each of the plurality of communication paths for the communication. In addition, the device may include a processor arranged in communication with the communication component and the cost component, the processor configured to generate a listing of the costs for each of the plurality of communication paths and receive a request to use one of the communication paths.

### RELATED APPLICATIONS

This application claims priority U.S. patent application Ser. No. 17/932,865 filed on Sep. 16, 2022, which claims priority to U.S. Provisional Patent Application No. 63/355,517 filed on Jun. 24, 2022, U.S. Provisional Patent Application No. 63/297,064 filed on Jan. 6, 2022, U.S. Provisional Patent Application No. 63/289,063 filed on Dec. 13, 2021 and U.S. Provisional Patent Application No. 63/248,898 filed on Sep. 27, 2021, all of which are hereby incorporated by reference in their entirety.

### TECHNICAL FIELD

This disclosure is generally directed to network communication systems. More specifically, this disclosure is directed to a network communication system with cost determination for communication paths.

### BACKGROUND

In network communication systems, not all paths are created equally. For example, although different paths may be available for a particular communication, one path may cost more than the other. Although a path may cost more, for various reasons, such a path may still be selected. Difficulties can arise to ever-changing network paths due to uncertainty as to the path costs and, also, ever-changing communication path availability as new paths become available and existing pathways are no longer available.

### SUMMARY OF THE DISCLOSURE

According to an embodiment of the disclosure, a network communication system with cost determination for communication paths is provided.

A system comprising one or more computers can be configured to perform specific operations or actions through the use of software, firmware, hardware, or a combination thereof. When operational, these components cause the system to execute the desired actions. Similarly, one or more computer programs may include instructions that, when executed by a data processing apparatus, enable the apparatus to perform these actions.

In one general aspect, a communication system disclosed. The system includes a cos component configured to determine costs associated with a plurality of communication paths for a communication. The system also includes a processor in communication with both the communication component and the cost module. The processor is configured to Generate a listing of costs for each of the plurality of communication paths; and receive a request to use one of the communication paths.

Other embodiments of this aspect may include corresponding computer systems, apparatuses, and computer programs stored on one or more computer-readable storage devices, each configured to perform the methods described.

Implementations of the system may include one or more of the following features:
A network communication system with an interface that facilitates user interaction and selection of communication paths.
A processor configured to send the communication based on input received from a user.
A dynamically updated listing of communication paths as new paths become available or existing paths are removed.
A processor configured to set a base cost based on the highest-cost path and provide cost differences for alternative paths.
Determination of different costs for the same paths based on an entity's profile associated with the communication.
Determination of different costs for the same paths based on multiple associated communications.
Inclusion of wireless communication paths among the plurality of communication paths.
Inclusion of wired network paths among the plurality of communication paths.
A storage component configured to store historical data related to past communications and their associated costs.
A processor that uses historical data to predict future costs for similar communications.
A processor configured to prioritize low-cost paths based on predefined user preferences or policies.
A security component that authenticates users before allowing access to select or initiate a communication.
The described techniques may be implemented using hardware, software (methods or processes), or computer-readable media.

In another general aspect, a method is disclosed that includes determining costs for different communication paths capable of handling a communication; generating a list of costs for these communication paths for selection; and receiving, via a processor, a request to use a particular communication path for the communication.

Other embodiments may include corresponding computer systems, apparatuses, and computer programs stored on one or more computer-readable storage devices, each configured to perform these methods.

Implementations of the method may include one or more of the following features:
Receiving, via a user interface, a selection of a particular communication path.
Making selections based on an entity's profile.
Determining a base cost based on the highest-cost path among available options.
Dynamically updating the listing by removing unavailable paths in real time as network conditions change.
Determining an optimal path based on user-specified requirements such as cost or latency preferences.
Encrypting data transmitted over selected communication paths to ensure secure transmission during communications.

The described techniques may be implemented using hardware, software (methods or processes), or computer-readable media.

### BRIEF DESCRIPTION OF THE DRAWINGS

For a more complete understanding of this disclosure and its features, reference is now made to the following description, taken in conjunction with the accompanying drawings, in which:

FIG. 1 shows a block diagram of a communication system, according to an embodiment of the disclosure;

FIG. 2 shows a listing depicting costs, according to an embodiment of the disclosure;

FIG. 3 shows a view of a user interface, according to an embodiment of the disclosure;

FIG. 4 shows another listing depicting costs, according to an embodiment of the disclosure; and

FIG. 5 shows a method for performing a communication according to an embodiment of the disclosure.

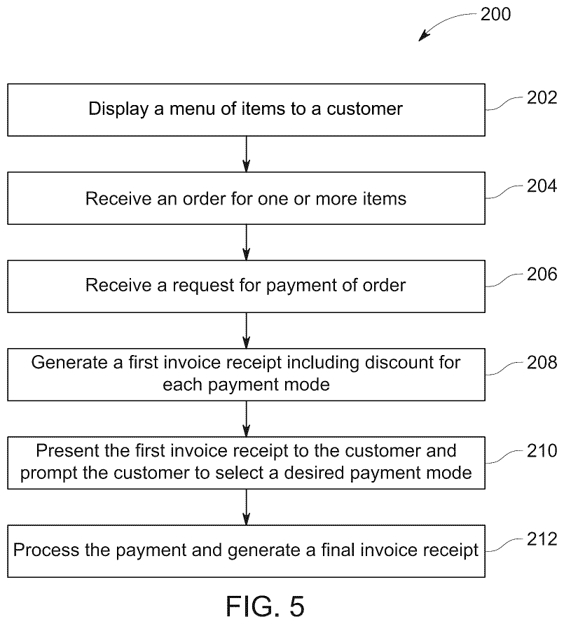

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc., mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

Additionally, it should be understood that while certain advantages may be described with reference to certain embodiments, other embodiments may have some or none of such advantages.

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

It will be understood that well known processes and components have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

Additionally, although described in the context of oil and gas applications, other industrial processes can avail from the teachings of this disclosure.

Given the negative consequences of surcharges described above, embodiments of the disclosure provide a systematic way of providing cash discounts in point-of-sale systems (POS)—including existing pointof0sales systems. The Durbin Amendment allows businesses to offer discounts as an incentive for customers to pay by alternative methods. In particular, it is considered an “in-kind” incentive in compliance with Section (2)(A) of the Durbin Amendment, a provision of United States Federal Law, 15 U.S.C & 169o-2. A Cash Discount from the regular price in accordance with section (4)(c)(4) of the same document can be provided Cash discounts are not presently prohibited in any state—minimizing the need to figure out compliance. When such a cash discount program is implemented, a merchant simply hangs a sign indicating that a cash discount is available. And, in effect, many of the benefits of attempting to recover fees from use of credit cards.

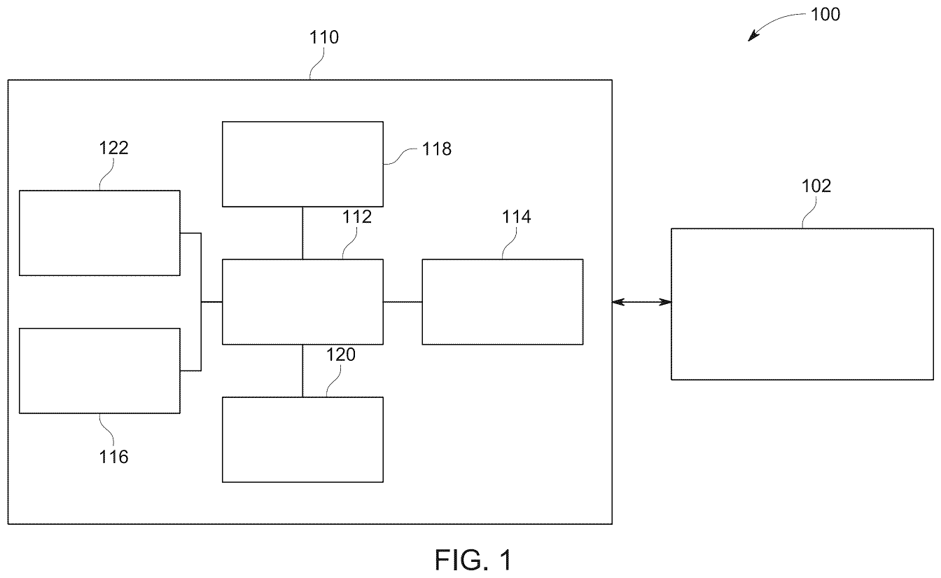

Referring to FIG. 1, a particular type of communication system is shown—a point-of-sale system 100 (hereinafter referred to as POS). However, thers may be utilized. In an implementation, various sub-systems or the modules of the POS system 100 may be implemented using a server and may be accessed via a user device. In some embodiments, various sub-systems or the modules POS system may be implemented using a local computing device, for example, a tablet. The POS system 100 may include a user interface 102 (shown in FIG. 1) to facilitate a generation of at least an invoice for a purchase order and enables an interaction of a user, for example, a customer and/or a merchant, with the POS system. In an embodiment, the user interface 102 may be a graphical user interface to facilitate the user to interact with the POS system. In some embodiments, the user interface 102 may be a web-based application that can be accessed by a computing device, such as, but not limited to, a mobile phone, a desktop computer, a laptop, a tablet, or any other similar device that facilitates an access of the web-based application. The user interface 102 is in communication with a controller 110 of the POS system 100 to receive inputs from the user via the user interface 102, and process the inputs to generate the at least one invoice and process the payment corresponding the generated invoice for the purchase order.

In an embodiment, the controller 110 may include a processor 112, a menu module 114, a payment module 116, a price module 118, a discount module 120, and a customer database 122, etc. The processor 112 is arranged in communication with the menu module 114, the payment module 116, the price module 118, the discount module 120, and the customer database 122, and facilitates a generation of the invoice and processing of the payment based on inputs/selection received from the user through the user interface 102.

The menu module 114 is a database that includes a list of available items for sale. Further, each item is assigned a unique identifier to facilitate an easy access and retrieval of the item and corresponding price of the item. The menu module 114 may be accessed by the user via the user interface 102. In some embodiments, the items stored inside the menu module 114 may be arranged/stored/associated with a category, and all the items related to the category may be accessed via the user interface 102 upon selection of the category.

The price module 118 may include price corresponding to each of the item stored inside the menu module 114. Further, the price module 118 may be in communication with the payment module 116 and may determine a highest payment fee among the payment fees levied by various payment modes. Based on the highest payment fee, price for each item is determined. In an embodiment, the price for each item is calculated/determined by adding the highest payment fee to a basic price of the associated item.

The payment module 116 includes a list of a plurality of payment modes for making the payment for a purchase order, and facilitates payment of the purchase order through one or more of the payment modes. The plurality of payment modes includes a cash payment mode and at least one non-cash payment mode. Non limiting examples of the non-cash payment mode includes a credit card based payment mode, a debit card based mode of payment, a wallet based payment mode, a crypto based payment mode, etc. The user may access the payment module 116 via the user interface 102 and selects a desired payment mode. Further, the payment module 116 includes a payment fee associated with each mode of payment. Further, the payment module 116 is in communication with the discount module 120, and the discount module 120 is configured to access the payment fee for each payment mode and determines a discount corresponding to the associated payment mode.

The processor 112 is configured to display, via the user interface 102, various items available for purchase and associated price for each item to the user. The processor 112 is configured to display and provide access of the user interface 102 to the user upon receiving a request from the user to access the POS system 100. In an embodiment, the processor 112 may receive the request to access the POS system 100 when the user access a web based application stored in a user device or by accessing a website associated with the POS system 100 or POS system 100 installed on a local computing device, for example, a tablet. Further, the processor 112 is configured to receive inputs from the user and enables a selection, via the user interface 102, of one or more items available for purchase. It may be appreciated that the user interface 102 is configured to display a name of the item and associated price with the item. It may be appreciated that the processor 112 is configured to update the price of each item based on any changes in the highest fee being charged among the available payment modes.

Upon selection of the one or more items, the processor 112 is configured to determine if an input associated with initiating a payment for the selected items (i.e., the purchase order) is received. Upon receiving an input for initiating the payment for the purchase order, the processor 112 is adapted to initiate the payment of the ordered/selected items i.e., the purchase order. For so doing, the processor 112 is configured to generate a first invoice receipt 150 corresponding to the purchase order.

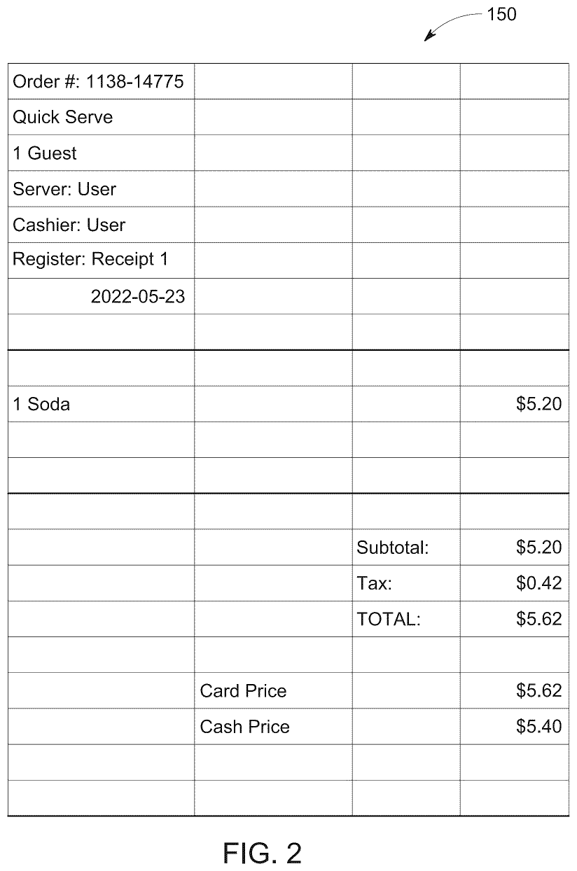

In an embodiment, the first invoice receipt 150 (shown in FIG. 2) includes a name of each ordered/purchased item and associated price of the item, the applicable tax, for example, sale tax, on the purchase of the ordered items, a total amount to be paid corresponding to the ordered items, and a discounted total amount corresponding to each payment mode. The processor 112 may be configured to display/show/share the first invoice receipt 150 to a customer/user. In an embodiment, the processor 112 may be configured to share the first invoice receipt 150 with the customer (i.e., the user) through the user interface 102. In some embodiments, the processor 112 may share a web based link to the user via a message, and the user can open and view the first invoice receipt 150 by accessing the web based link via the user device. In some embodiments, the processor 112 is configured to enable a physical print of the first invoice receipt 150 which can be shown to the customer by the merchant. Also, the processor 112 is configured to store the first invoice receipt 150 in the customer database 122 and associates the first invoice receipt 150 with the purchase order for later retrieval. It may be appreciated that the stored first invoice receipt 150 may be retrieved by using a number/identifier, for example, a purchase order number, associated with the purchase.

In some embodiments, the processor 112 is configured to determine if the customer is a recurring customer and may provide an additional discount depending upon the payment mode chosen/selected by the customer/user. For example, the processor 112 may calculate the discount applicable for each payment mode being equal to the fee associated with each payment mode upon determination that the customer is a recurring customer. Accordingly, the final price of the purchased items (i.e., purchase order) may be identical for each of the payment modes when the customer is a recurring customer.

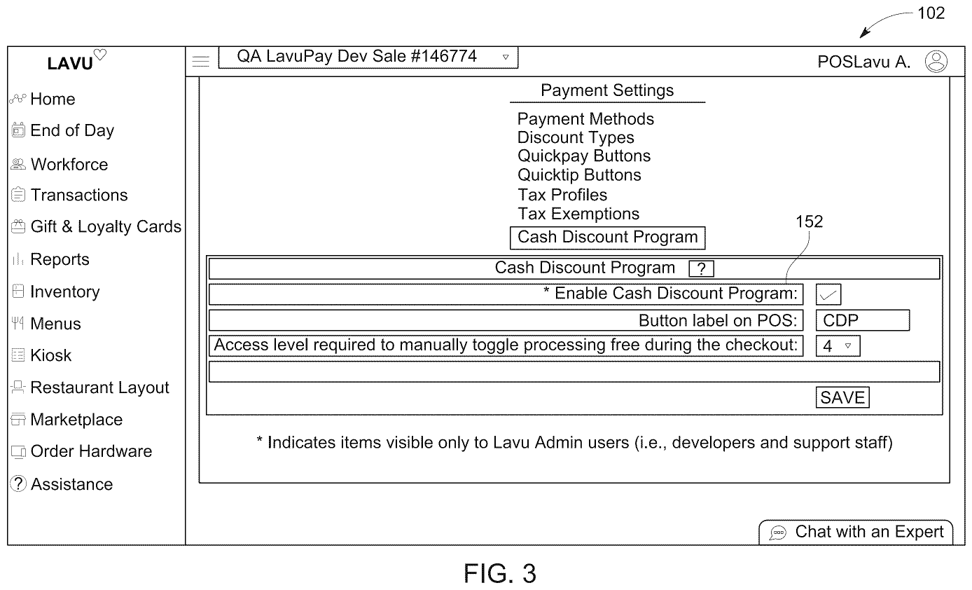

In some embodiments, the processor 112 may provide an option to enable or disable the discounts to be applied corresponding the payment mode. For so doing, the processor 112 may allow a selection by the merchant through the user interface 102 to select whether discounts corresponding the payment mode are applicable or not application. As shown in FIG. 3, the user interface 102 may provide a drop-down menu 152 and the merchant is able to select the desired option from the drop down menu. It may be appreciated that the processor 112 may include the discounts application to the payment modes only when the discount option is enabled.

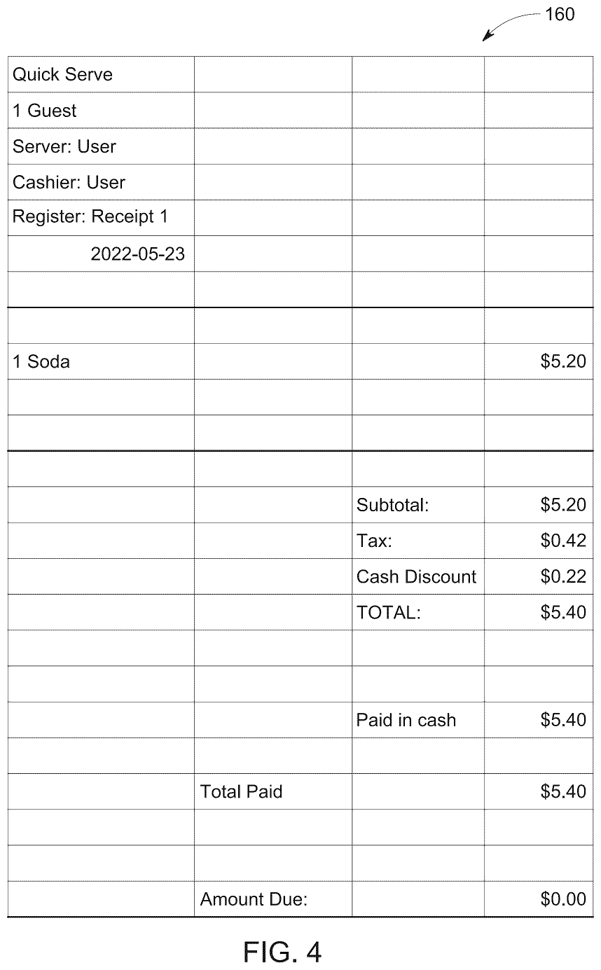

Based on the selection of the payment mode, the processor 112 is configured to process the payment and generate a final invoice receipt 160 (as shown in FIG. 4). The final invoice receipt 160 may include price for each item, the applicable tax, the mode of payment and the amount of discount, and the final amount paid by the customer/user. In this manner, the POS system 100 incentivize one payment mode over the other, reducing the overall fee paid to the payment provider. In some embodiments, the highest fee is charged by a credit card based payment mode and accordingly, the highest amount of discount is applied for a customer that selects the cash mode as the payment mode.

In an embodiment, the processor 112 may determine the selection of the desired payment mode based on the inputs received from the customer or merchant through the user interface 102. Alternatively, the processor 112 may detect/determined the desired mode of payment automatically. For example, the processor 112 may determine the desired payment mode as the credit card based payment mode when the processor detects/determine a swiping of a credit card. In some embodiments, the processor 112 may determine the payment mode as the wallet based payment mode when a QR code is scanned. In such a scenario, the processor 112 may determine the payment mode as cash based payment mode when automatic input is missing.

An example method 200 for providing a discount to a customer or carrying out a transaction is now disclosed with reference to processing a payment using the POS system 100 for a restaurant. The method 200 includes at step 202 of displaying a menu of the items to a customer. In an embodiment, the menu may be displayed to the customer via a suitable device, for example, the tablet, etc. In some embodiments, the customer accesses the menu by scanning a code, for example, a QR code, via a user device, for example, a mobile phone. Accordingly, the QR code enables an easy access of the menu or the user interface 102 of the POS system 100.

Thereafter, at a step 204 of the method 200, the customer selects one or more items from the menu and order the order the one or more items for delivery. In an embodiment, the customer may select the one or more items in the menu through the user interface 102 and may place the order through the user interface 102. In some embodiments, the customer may tell his choice of items to an assigned waiter (i.e., merchant) of the restaurant, and the waiter may input the selected items through a user device of the restaurant. Upon receipt of the inputs for the selected items, the processor 112 generates an order number and stores the information related to the order inside a database. In some embodiments, the processor 112 may prompt the user (i.e., the customer or the merchant), via the user interface 102, to input information related to the customer. For example, the processor 112 may prompt the user to input name of the customer, age of the customer, a phone number of the customer etc., to create or access a profile of the customer into the POS system 100. The processor 112 is configured to store the profile of a new customer containing the details inside the customer database 122. In an embodiment, the processor 112 may associate/relate/pair the order with the customer profile for lateral retrieval. Accordingly, the processor 112 may allow a user to access and view the details of the previous orders placed by the customer. Further, based on the customer profile and previous purchase history of the customer, the processor 112 may determine if the customer is repeat customer and assigns a loyalty benefit to the customer.

Further, the method 200 includes a step 206 for receiving a request for the payment corresponding to the purchase order from the customer. In an embodiment, the processor 112 may receive the request for payment through the user interface 102 accessed via the customer device or by entering the payment request through the device of the restaurant. Upon receiving the payment request, the processor 112, at a step 208 of the method 200, may access the discount module 120 and the payment module 116, and generates a first invoice receipt 150 corresponding to the purchase order number. In an embodiment, the waiter of the restaurant may input the order number via the user interface 102 to facilitate the generation of the first invoice receipt 150. In the illustrated embodiment, the POS system 100 (i.e., the payment module) may include two payment modes, a credit card based payment mode and a cash based payment mode. Accordingly, the processor 112 determines the discount corresponding to the cash based payment mode, and list the final price to be paid for each payment mode (as shown in FIG.). In some embodiments, before applying discounts corresponding to each payment mode, the processor 112 may determine if the discount option is enabled or disabled, and proceed to determine the discount and associated payable amount corresponding to each payment mode only when the discount option is enabled.

As shown in FIG. 2, the first invoice receipt 150 includes total price calculated based on the price for all the items, i.e., soda, and the applicable sale tax. Also, the first invoice receipt 150 includes a first payable amount corresponding to the credit card based payment mode and a second payable amount corresponding to the cash based payment mode. As can be seen from FIG. 2, the discount is provided only for the cash based payment mode, while the first payable amount is equal to the total price calculated without the discount. In some embodiments, before determining the discount applicable for each payment mode, the processor 112 may determine/check the customer profile and determine any loyalty benefit available for the customer, and calculates the payable amount for the purchase order based on the loyalty benefit. For example, in some embodiments, the first payable amount and the second payable amount may be equal based on the loyalty benefit available to the customer.

In some embodiments, the first payable amount may be reduced by deducting the discount available for the customer based on the loyalty benefit. In some embodiments, in addition to the payment mode and the loyalty benefit, the processor 112 may determine the discount based on total price of the order. For example, the processor 112 may also apply the discount to the credit card based payment mode when the total price before the discount is above a predefined value. For example, the processor 112 may apply to discount to the total price such that the first payable amount to be equal to the second payable amount when the total price is USD 100. Accordingly, the payable amount corresponding to each payment mode is equal when the total amount before discount is above the predefined value.

In an embodiment, the processor 112 may apply the discount to credit card based payment mode such that the total price before discount is below a predefined threshold. For example, the processor 112 may determine the first payable amount to be equal to the second payable amount when the total price is less than USD 2. Accordingly, the payable amount corresponding to each payment mode is equal when the final price before discount is below the predefined threshold.

The method 200, at step 210, also includes presenting the first invoice receipt 150 to the customer and prompting the customer to select the desired payment mode. In an embodiment, the processor 112 may present the first invoice receipt 150 via the user interface 102. In an embodiment, the processor 1012 may share/send a message or an email having a weblink/web address through which the customer can access the first invoice receipt 150 via the customer device, for example, mobile phone, tablet, or laptop. In some embodiments, the customer is able to select the desire payment mode through the user interface 102 accessed via the customer device. In some scenarios, the processor 112 may prompt the waiter (i.e., merchant) of the restaurant to physical print the first invoice receipt 150 and present the printed first invoice receipt to the customer. The waiter of the restaurant input the desired payment mode into the POS system 100 through the user interface 102 based on the input from the customer.

Upon receiving the input corresponding to the desired payment mode, the method 200 includes a step 212 in which the processor 112 processes the payment and generates the final invoice receipt 160. Upon receipt of the payment, the final invoice receipt 160 is shared with the customer in a manner similar to the sharing of the first invoice receipt 150 with the customer. Moreover, the processor 112 may save a copy of the final invoice receipt 160 into the customer database 122 and associate the final invoice receipt 160 with the order number and customer profile. In this manner, the POS system 100 provides differential pricing to the customer based on the payment mode and reduces the overall fee that need to be paid to the service providers of the various payment modes.

In some embodiment, POS system 100 may also allow to generate a plurality of first invoice receipts 150 and a plurality of final invoice receipts 160 for a purchase order to allow a splitting of the bill for a table at the restaurant/merchant. In an embodiment, the processor 112 may prompt the waiter or the customer to select to generate a single first invoice receipt 150 or a plurality of first invoice receipts 150 corresponding to the purchase order at the restaurant. Based on the selection of the plurality of the first invoice receipts 150, the processor 112 may ask a number of first invoice receipts 150 to be generated. For generating the plurality of first invoice receipts 150, the processor 112, in some embodiments, may divide the total amount of the purchase order into equal values and generates the first invoice receipts of the equal amounts. For example, when the single bill is to be divided into two, the processor 112 may divide the total amount into two equal halves and generates two first invoice receipts 150 corresponding to the purchase order. In such a case, in some embodiments, the processor 112 may determine the discount value corresponding to each of the payment mode to be zero.

In some embodiments, after dividing the total amount of the purchase order into various equal amounts for generating the plurality of first invoice receipts 150, the processor 112 may calculate the discount available for each payment mode and list the payable amount for each payment mode in each of the first invoice receipts 150 and share the first invoice receipts 150 with the customers associated with the purchase order. Thereafter, the processor 112 may process the payment corresponding to each first invoice receipt 150 separately based on desired payment mode for each first invoice receipt 150, and generates the final invoice receipt 160 corresponding to each first invoice receipt 150 as disclosed above with reference to a single final invoice receipt 160 for a purchase order.

In some embodiments, the processor 112 may process the split bill based on the items of the individual customer of the plurality of the customers. In such a case, the processor 112 may prompt the waiter (i.e., merchant) or one or more of the customers to input details associated with each customer as well the items purchased by each customer. Based on each customer detail and the associated purchased item(s), the processor 112 may generate a first invoice receipt 150 for each customer of the plurality of customers. In such a scenario, the processor 112 may treat each split of the purchase order as a separate order and generates the first invoice receipt 150 in a manner similar to the generation of first invoice receipt 150 for the individual order. Upon generating the first invoice receipt 150 for each customer, the processor 112 present the first invoice receipts 150 to plurality of customers, receives a selection of the desired payment mode corresponding to each first invoice receipt, process the payment and generate final invoice receipts 160 in a manner identical the processing and generation of the final invoice receipt 160 for a single purchase order as described above.

While this disclosure has described certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims. As a non-limiting example, while a particular application has been described, the described process may be used with other oilfield applications and industrial applications.

1. A Point of Sale (POS) system, comprising:
a network interface configured to provide access to a plurality of payment processing routes for handling a financial transaction for a user;
a processor operatively coupled to the network interface; and
a memory communicatively coupled to the processor and storing instructions that, when executed by the processor, configure the processor to:
determine merchant processing fees associated with each of the plurality of payment processing routes by retrieving and applying respective fee structures for each route;
generate a listing of the merchant processing fees for each of the plurality of payment processing routes;
present, to a user via a user interface of the POS system, the merchant processing fees of at least two different payment processing routes for the financial transaction;
receive a selection, from the user, to use one of the payment processing routes; and
execute the financial transaction with the user-selected payment processing route.

2. The POS system of claim 1, further comprising a touchscreen interface to facilitate user interaction and selection of a payment processing route.

3. The POS system of claim 1, wherein the processor and memory are part of a point of sale system.

4. The POS system of claim 1, wherein the listing of payment processing routes is dynamically updated as new payment processing routes become available or existing payment processing routes are no longer available.

5. The POS system of claim 1, wherein the processor is configured to:
determine particular payment processing routes available for the user, wherein select payment processing routes are unavailable to select users; and
set a base cost for the financial transaction based on the highest cost payment processing route and provide an indication of cost differences for alternative payment processing routes.

6. The POS system of claim 1, wherein the processor determines different merchant processing fees for same payment processing routes based on the profile of users an entity associated with the financial transaction.

7. The POS system of claim 1, wherein the processor is configured to determine different merchant processing fees for same payment processing routes based on multiple associated financial transactions.

8. (canceled)

9. (canceled)

10. The POS system of claim 1, wherein the payment processing routes are selected from the group consisting of a payment processor, a blockchain network, and a server associated with a payment application, the POS system further comprising a storage configured to store historical data related to past financial transactions and their associated merchant processing fees.

11. (canceled)

12. The POS system of claim 1, wherein the processor is further configured to prioritize low-cost payment processing routes based on predefined user preferences or policies.

13. The POS system of claim 1, further comprising a security component configured to authenticate users before allowing access to select or initiate a financial transaction.

14. A method for selecting a payment processing route Point of Sale (POS) system, comprising:
determining merchant processing fees associated with a plurality of different payment processing routes capable of handling a financial transaction for a user, wherein the determining comprises retrieving and applying respective fee structures for each route;
generating a list of the merchant processing fees for the different payment processing routes for selection;
presenting the list to the user via a user interface of the POS system with an indication of cost differences between the payment processing routes;
receiving, by a processor, a selection of a payment processing route from the plurality of different payment processing routes; and
executing the financial transaction using the selected payment processing route.

15. The method of claim 14, further comprising receiving, via the user interface, a selection of the particular payment processing route.

16. The method of claim 15, wherein the selection is based on a profile for a particular entity associated with the financial transaction.

17. The method of claim 14, wherein a base cost is determined based on the highest cost among available payment processing routes capable of handling the financial transaction.

18. The method of claim 14, wherein dynamically updating the listing includes removing unavailable payment processing routes from consideration in real time as conditions change.

19. The method of claim 14, further comprising determining an optimal payment processing route based on requirements specified by an application or user.

20. The method of claim 14, further comprising encrypting data transmitted over the selected, payment processing route to ensure secure transmission during communication of the financial transaction.
